(19) United States
(12) Patent Application Publication
(10) Pub. No.: US 2008/0244983 A1
(43) Pub. Date: Oct. 9, 2008

(54) Single universal adjustable gate hinge

(76) Inventor: Burdette D. Peterson, Colbert, WA (US)

Correspondence Address: BERGMAN & JECKLE P.L.L.C., 421 W. RIVERSIDE, SUITE 717, SPOKANE, WA, 99201, US

(21) Appl. No.: 11/732,461

(22) Filed: Apr. 4, 2007

(51) Int. Cl. E05D 15/00

(52) U.S. Cl. 49/381

(57) ABSTRACT

A single universal adjustable gate hinge pivots about two mutually perpendicular axes and provides a pivot beam pivotally fastened to an anchoring gatepost between an upper and lower angle axle brace. A support collar defining a medial through channel and structurally carrying two spaced apart parallel mounting brackets is slidably carried on the pivot beam. A pivoting gate bracket rigidly fastened to one end portion of a gate with collar clamps is journaled between the two mounting brackets on a gate pivot pin. A height securing pin extending through vertically spaced holes defined in the pivot beam and support collar allow the vertical position of the gate to be adjusted. A gate pivot pin extending through horizontally spaced holes defined in the mounting brackets and a medial gate pivot pin hole defined in the pivoting gate bracket allow the lateral position of the gate to be adjusted.

### BACKGROUND OF INVENTION

1. Related Applications

There are no applications related hereto heretofore filed in this or in any foreign country.

2. Field of Invention

This invention relates to movable closures and miscellaneous hardware therefor, and more particularly to gate hangers and hinges.

### BACKGROUND AND DESCRIPTION OF PRIOR ART

Gates are commonly rigid elongate structures that are swung on gate hinges to block an entrance or passageway. Gate hinges are jointed devices that allow the swinging or pivoting of the gate relative to a stationary part, commonly an anchoring gatepost and are carried at the one end portion of the gate forming a vertical axis about which the gate swings.

Gates may be installed in pairs where two separate gates are elongately aligned to close the entrance or passageway. In such an installation, each gate spans approximately half of the entrance or passageway to be closed and is mounted to and swings relative to one gatepost that defines an edge of the entrance or passageway. Alternatively, gates may be installed singly where one elongate gate spans the entire opening or passageway. Single gates are more common and generally more popular because they are less expensive and easier to install, because only one anchoring gatepost is required and because gate alignment problems are minimized.

A drawback to all hinged gates and especially to elongate single gates is that gravity causes the gate to act as a lever arm against the hinges which exerts continuous pressure on the hinges and a torquing force on the anchoring gatepost. Further, elongate single gates typically require substantial anchoring gateposts to support the gate and withstand the leverage forces generated by gravity working on the lever arm of the gate. Such anchoring gateposts can be expensive and at times impractical or even impossible to install especially if the soil is rocky.

One solution to various of the above mentioned drawbacks is a weight bearing wheel on a bottom edge of the gate opposite the hinges. The wheel carries the weight of the gate and reduces the leverage forces exerted on the hinges and gatepost. Wheels unfortunately have drawbacks as well. If the ground surface under the gate is not level, the wheel may be contact with the ground at one point and suspended from the gate at another point. When the wheel is suspended, the leverage forces on the hinges and gatepost are increased even further. Uneven terrain under a gate is common because traffic, be it vehicular, foot or animal, is concentrated at the gate which compresses the ground surface causing ruts and grooves.

Equally as detrimental as grooves and ruts, protuberances from the ground along the wheel's course of travel also cause leverage forces that are exerted against the hinges and anchoring gatepost as the wheel travels up and over the protuberance. These leverage forces cause the anchoring gate post to “rock” back and forth as the gate is opened and closed which eventually loosens the anchoring gatepost resulting in the gate being unstable and unsupported.

What is needed is a gate hinge that may be used with existing cattle panels and other rigid gate structures, that is easy to install, does not transfer leverage forces to the anchoring gatepost, is not negatively affected by uneven terrain under the gate, and is adjustable laterally as well as vertically.

My invention overcomes various of the aforementioned drawbacks by providing a single universal adjustable gate hinge that is releasably attachable to the inner end portion of a rigid gate structure such as a cattle panel. My gate hinge allows an attached gate to swing forwardly and rearwardly on a vertical axis provided by an elongate vertical pivot beam carried by angle braces mounted to the anchoring gatepost. My gate hinge further allows the attached gate to pivot upwardly and downwardly on a horizontal axis provided by a gate pivot pin extending horizontally through mounting plates of a support collar and a pivoting gate bracket. The outer end portion of the gate, opposite the hinge, is preferably supported on a rigid “U” shaped depending foot, or a ground traveling wheel aligned transversely to the elongate length of the gate.

My gate hinge allows elongate rigid gates, such as cattle panels, to be mounted on smaller anchoring gateposts because a large portion of the gate mass is supported on the ground at the outer end of the gate. My hinge is useful in situations where the terrain over which the ground engaging tire passes is rough, such as through and over tire ruts because the gate may pivot upwardly and downwardly as it swings.

My invention does not reside in any single one of the identified features individually but rather in the synergistic combination of all of its structures, which give rise to the functions necessarily flowing therefrom as hereinafter claimed.

### SUMMARY

My single universal adjustable gate hinge generally provides a single gate hinge having a pivot beam pivotally fastened to an anchoring gate post with upper and lower axle braces. A support collar having first and second mounting brackets is slidably carried on the pivot beam. A pivoting gate bracket is rigidly fastened to one end portion of a gate with collar clamps and is journaled between the first and second mounting brackets on a gate pivot pin.

In providing such an apparatus it is:

A principal object to provide a single universal adjustable gate hinge that pivots about two mutually perpendicular axes.

A further object to provide such a gate hinge that is vertically adjustable.

A further object to provide such a gate hinge that is laterally adjustable.

A further object to provide such a gate hinge that is usable with a variety of rigid gate structures.

A further object to provide such a gate hinge that is easy to install.

A still further object is to provide such a gate hinge that reduces leverage forces applied to an anchoring post as the gate is opened and closed.

Other and further objects of my invention will appear from the following specification and accompanying drawings which form a part hereof. In carrying out the objects of my invention it is to be understood that its structures and features are susceptible to change in design and arrangement with only one preferred and practical embodiment of the best known mode being illustrated in the accompanying drawings and specified as is required.

### BRIEF DESCRIPTIONS OF DRAWINGS

In the accompanying drawings which form a part hereof and wherein like numbers refer to similar parts throughout:

FIG. 1 is an isometric front, top and inner end view of my universal adjustable gate hinge mounted to an anchoring gate post and supporting an elongate rigid gate.

FIG. 2 is a partial cutaway orthographic front view of the gate hinge attached to an anchoring fence post and supporting a gate.

FIG. 3 is orthographic view, similar to that of FIG. 2 showing the back of the gate hinge.

FIG. 4 is an orthographic end view of the gate hinge of FIG. 2 looking toward the anchoring gatepost.

FIG. 5 is an orthographic top view of the gate hinge of FIG. 2.

FIG. 6 is an orthographic bottom view of the gate hinge of FIG. 2.

FIG. 7 is an orthographic front view of the gate hinge attached to an anchoring gatepost and supporting a gate, showing a user in phantom outline operating the gate.

### DESCRIPTION OF PREFERRED EMBODIMENT

As used herein, the term “inner”, its derivatives, and grammatical equivalents refers to that portion of a gate closest to an anchoring gatepost. The term “outer”, its derivatives, and grammatical equivalents refers to the portion of the gate most distant from the anchoring gatepost.

My universal adjustable gate hinge provides a pivot beam 10 pivotally fastened to an anchoring gatepost 53 with upper and lower axle braces 14. A support collar 20 having a structurally attached first mounting bracket 21 and a spaced apart parallel second mounting bracket 22 is slidably carried on the pivot beam 10. An elongate pivoting gate bracket 30 is rigidly fastened to a first inner vertical end portion 43 of a gate 40 with collar clamps 37 and is pivotally journaled between the first 21 and second 22 mounting brackets on a gate pivot pin 28.

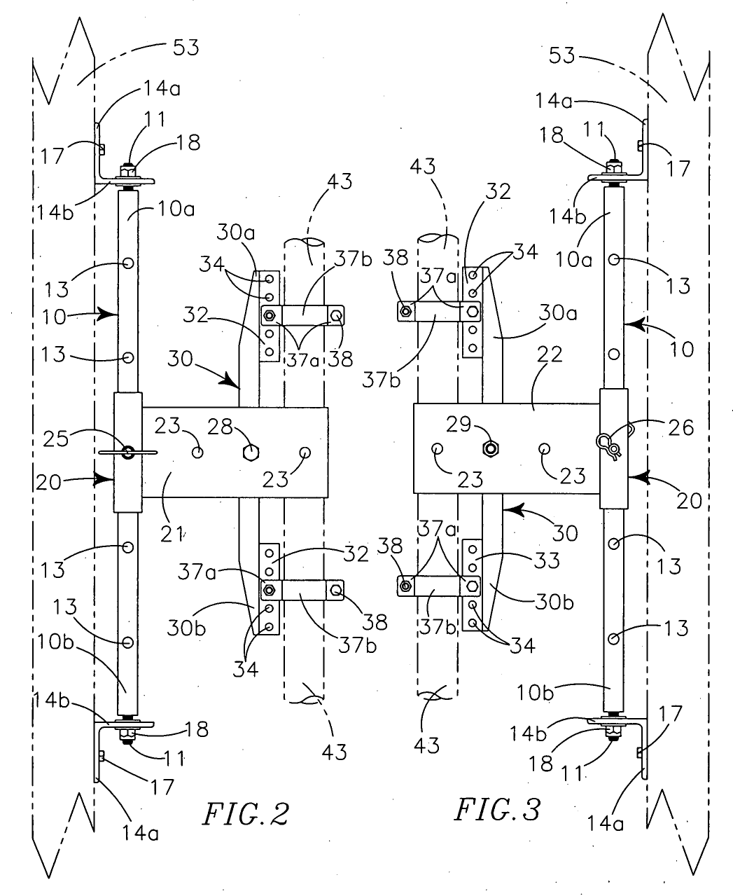

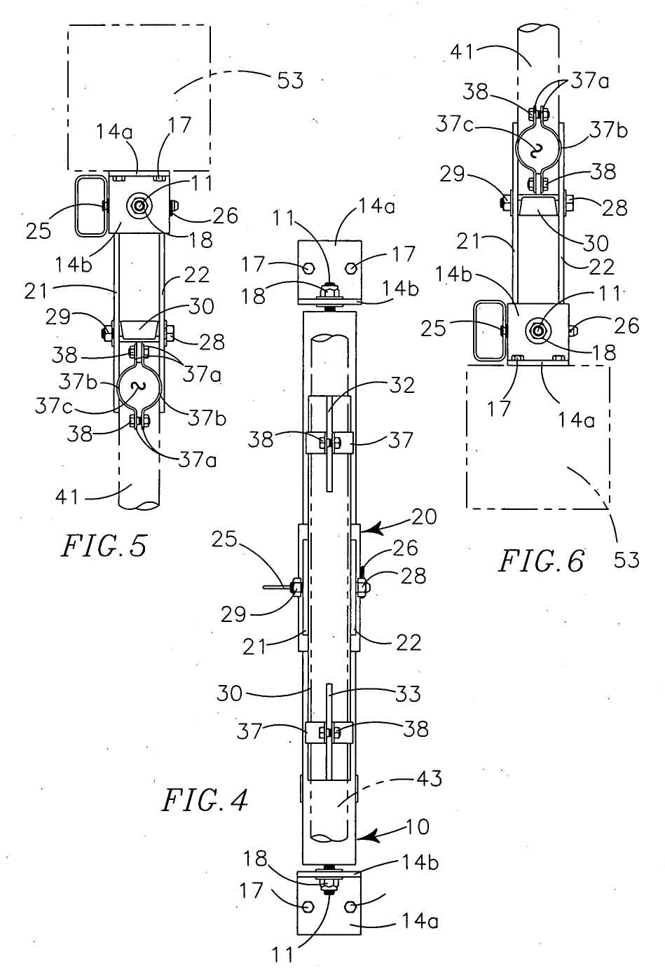

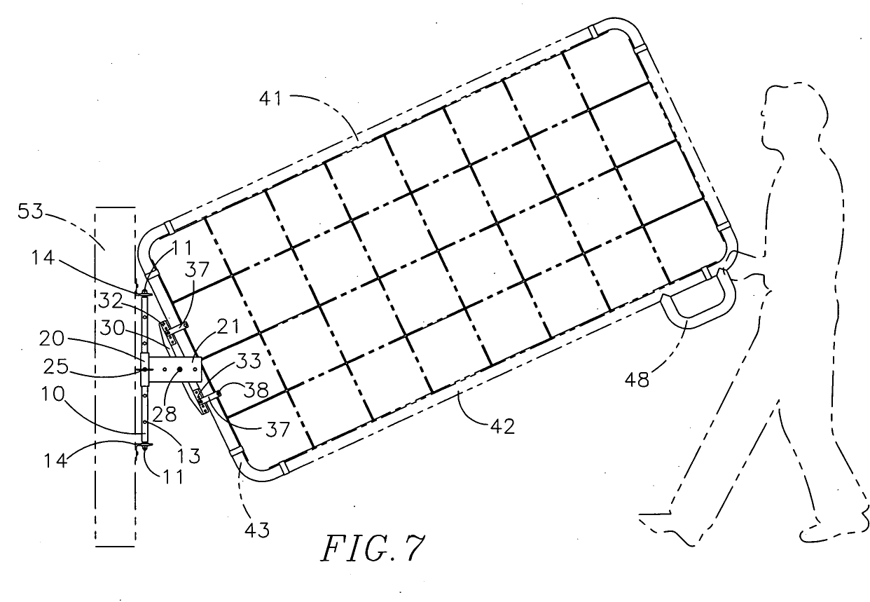

As shown in FIGS. 2 and 3, the pivot beam 10 is a box beam having an upper end portion 10a, a lower end portion 10b and defines plural vertically spaced height adjustment holes 13 therein. Pivot axles 11 are structurally carried at the upper end 10a and lower end 10b portions and extend axially outwardly therefrom to releasably engage with axle braces 14 that are mounted to an anchoring gatepost 53. The pivot axles 11 are preferably threaded and each may releasably carry a threaded fastener 18, such as a nut.

The axle braces 14 are angle brackets each having a vertically extending anchor post flange 14a and a horizontally extending gate pivot flange 14b. Through holes 15 are defined in each anchor post flange 14a to carry lag-bolt type fasteners 17 therein to securely fasten the axle brace 14 to the anchoring gatepost 53. A medial axle hole (not shown) is defined in each gate pivot flange 14b to carry one pivot axle 11 of the pivot beam 10.

The support collar 20 is a section of box beam defining a medial through channel (not shown) sized so the pivot beam 10 slidably extends axially therethrough. A height adjustment hole 24 is defined in the support collar 20 for a height securing pin 25 to be inserted therein and therethrough and simultaneously through a pair of aligned height adjustment holes 13 defined in the pivot beam 10. The height securing pin 25 positionally maintains the support collar 20 on the pivot beam 10 so that the vertical position of the support collar 20 and the gate 40 may be adjusted as desired.

A first rectilinear mounting plate 21 and a second rectilinear mounting plate 22 are structurally carried by the support collar 20 and extend in parallel spaced adjacency outwardly therefrom perpendicular to the pivot beam 10. Plural horizontally spaced adjustment holes 23 are defined in each mounting plate 21, 22 to removably carry a gate pivot pin 28 that extends horizontally therethrough and therebetween allowing the lateral position of the attached pivoting gate bracket 30 and gate 40 to be adjusted and providing a horizontal axis about which the gate 40 may pivot.

The pivoting gate bracket 30 is elongate and has an upper end portion 30a structurally carrying a first upper flange 32, a lower end portion 30b structurally carrying a second lower flange 33 and defines a gate pivot pin hole (not shown) at a generally medial position between the upper 30a end and lower 30b end portions. The pivoting gate bracket 30 is journaled between the first and second mounting plates 21, 22 respectively, and the gate pivot pin 28 extends through the adjustment holes 23 defined in the mounting plates 21, 22 and simultaneously through the gate pivot pin hole (not shown) providing a generally horizontal axis upon which the pivoting gate bracket 30 and gate 40 pivot relative to the pivot beam 10 and support collar 20.

The first upper flange 32 and the second lower flange 33 extend laterally outwardly from the pivoting gate bracket 30 opposite the support sleeve 20 and each defines plural vertically spaced height adjustment holes 34. Each flange 32, 33 releasably carries a two-piece collar clamp 37 that communicates with the first inner vertical side of 43 of the gate 40. The collar clamps 37 are releasably fastened to the flanges 32, 33 with nut and bolt type fasteners 38 that extend therethrough.

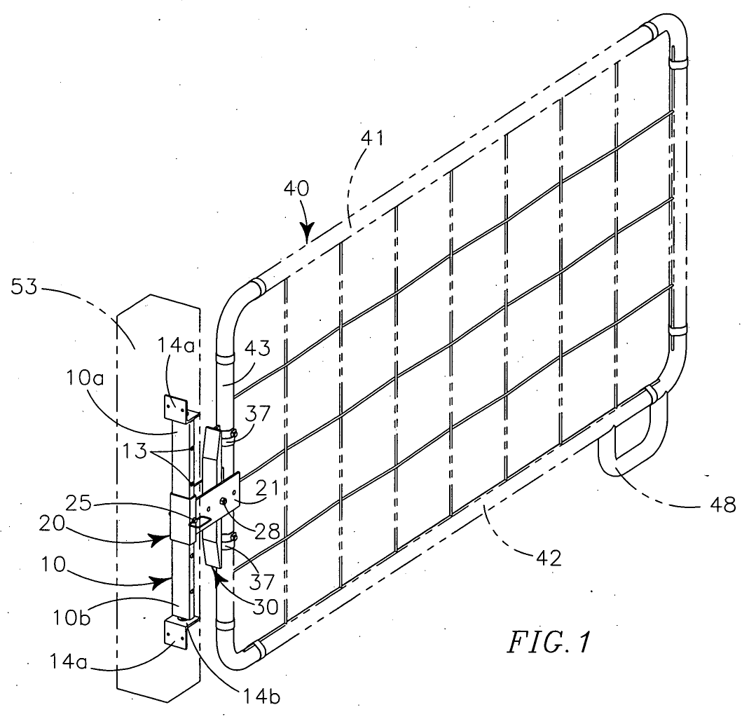

Each collar clamp 37 has two opposing halves, each half having a medial curve portion 37b and a fastener flange 37a at each end of the curve 37b. (FIGS. 5 and 6). The fastener flanges 37a each define a through hole (not shown) to carry a bolt and nut type fastener 38 that extends therethrough. When the two halves are aligned for installation, the medial curve portions 37b define an area 37c therebetween in which the first inner vertical side 43 of the gate 40 is carried. The collar clamps 37 are fastened to the first inner vertical side 43 of gate 40 preferably with one collar clamp 37 proximate to top rail 41 and the second collar clamp 37 proximate to bottom rail 42. (FIGS. 1, 2 and 3). Constrictive friction positionally maintains the collar clamps 37 on the first inner vertical side 43 of the gate 40 as the bolt and nut fasteners 38 extending through the holes in the fastener flanges 37a are tightened.

Having described the structure of my universal adjustable gate hinge, its assembly and operation may be understood.

An anchoring gatepost 53 adjacent one edge of a gap (not shown) in a fence (not shown) is selected for mounting the gate and hinge. One axle brace 14 is fastened to the anchoring gatepost 53 spacedly above the ground and on side portion adjacent the gap to be spanned by the gate 40, with fasteners 17 extending through the holes 15 defined in the vertical flange 14a.

The pivot beam 10 is positioned so that the pivot axle 11 at the lower end portion 10b passes through the axle hole (not shown) defined in the horizontal gate flange 14b of the axle brace 14 fastened to the anchoring gatepost 53. The support collar 20 is installed on the pivot beam 10 by sliding the pivot beam 10 into and through the medial channel (not shown) defined by the support collar 20. It is imperative the height adjustment hole 24 defined in the support collar 20 can be aligned with at least one pair of the height adjustment holes 13 defined in the pivot beam 10. The height securing pin 25 is inserted into and through the aligned holes 24, 13 respectively and is secured in place with a known retaining means 26, such as a cotter pin. (FIG. 3).

The pivot beam 10 is aligned so that it is generally vertical and parallel to the anchoring gatepost 53. The upper axle brace 14 is positioned so that the pivot axle 11 at the upper end portion 10a of the pivot beam 10 extends through the axle hole (not shown) defined in the horizontal gate flange 14b and the vertical anchor post flange 14a extends upwardly from the horizontal gate flange 14b. Fasteners 17 are inserted through holes 15 and secure the upper axle brace 14 to the anchoring gatepost 53. Nuts 18 are installed on the threaded pivot axles 11.

The pivoting gate bracket 30 is positioned adjacent the first inner vertical side 43 of the gate 40 with the first and second flanges 32, 33 respectively, adjacent the vertical side 43. The first upper collar clamp 37 is installed proximate to the top rail 41 of the gate 40 by positioning of the first half of the first collar clamp 37 so that the vertical side 43 of the gate 40 is within the curve portion 37b defined by the collar clamp 37 half. The second half of the first collar clamp 37 is positioned opposite the first half so that the collar clamp 37 extends circumferentially about the vertical side 43. A fastening bolt 38 is inserted through the aligned holes (not shown) defined in the fastener flanges 37a, and a cooperating fastener, such as a nut is threaded onto the bolt 38 and tightened securing the collar clamp 37 in position. A second fastening bolt 38 is inserted through the aligned holes (not shown) defined in the fastener flanges 37a at the opposite side of the curve portion 37b. After the second fastening bolt 38 is inserted through the holes (not shown) in the collar fastener flanges 37a the second bolt 38 is also inserted through one of the height adjustment holes 34 defined in the first upper flange 32 of the pivoting gate bracket 30. A cooperating threaded fastener, such as a nut is then threaded onto the bolt 38 and tightened. The above outlined collar clamp 37 installation procedure is repeated to install a second lower collar clamp 37 that communicates with the second lower flange 33 of the pivoting gate bracket 30, and the first inner vertical side 43 of the gate 40 proximate to the bottom rail 42. Tightening the bolt and nut combinations 38 positionally secures the collar clamps 37 and the gate bracket 30 to the gate 40.

The gate 40 is manipulated so that the gate 40 is generally vertical, resting upon the bottom rail 42 and the gate foot 48, or supporting wheel (not shown) if any. The inner end portion of the gate 40 carrying the pivoting gate bracket 30 is lifted so that the pivoting gate bracket 30 is between the first 21 and second 22 mounting brackets of the support collar 20. The gate pivot pin hole 31 defined in the pivoting gate bracket 30 is aligned with one of the horizontally spaced lateral adjustment holes 23 defined in the mounting brackets 21, 22 and the gate pivot pin 28 is inserted through the aligned holes 31, 23 and is secured in place with a known retaining means 29, such as a nut.

The vertical height of the gate 40 may be adjusted by changing the alignment of the height adjustment hole 24 in the support collar 20 with the height adjustment holes 13 defined in the pivot beam 10, and inserting the height securing pin 25 therethrough.

The lateral possession of the gate 40 may be adjusted by changing the alignment of the gate pivot pin hole 31 defined in the pivoting gate bracket 30 with the lateral adjustment holes 23 defined in the first and second mounting brackets 21, 22 respectively, of the support collar 20 and inserting the gate pivot pin 28 therethrough.

The foregoing description of my invention is necessarily of a detailed nature so that a specific embodiment of a best mode may be set forth as is required, but it is to be understood that various modifications of details, and rearrangement, substitution and multiplication of parts may be resorted to without departing from its spirit, essence or scope.

Having thusly described my invention, what I desire to protect by Letters Patent, and

What I claim is:

1: A gate hinge for pivotally attaching a rigid gate having an inner end an outer end a top rail and a bottom rail to a gatepost allowing the gate to pivot simultaneously horizontally and vertically for motion over variable terrain, the gate hinge comprising in combination:
a single gate hinge having two perpendicular axes for simultaneous pivoting in two mutually perpendicular directions.

2: The gate hinge of claim 1 further comprising:
a pivot beam having a pivot axle at an upper end and a pivot axle at a lower end and defining plural vertically spaced height adjustment holes between the upper end and the lower end pivotally mounted to the gatepost with axle braces communicating with the pivot axles;
a support collar defining a height adjustment hole for a height securing pin and a through channel slidably carried on the pivot beam and structurally carrying two parallel spacedly adjacent outwardly extending mounting brackets, each mounting bracket defining plural horizontally spaced lateral adjustment holes to carry a gate pivot pin; and
a pivoting gate bracket rigidly attached to the inner end portion of the gate and defining a medial gate pivot pin hole journaled between the mounting brackets on the gate pivot pin.

3: The gate hinge of claim 2 wherein:
the height securing pin is releasably carried in and extends through the height adjustment hole defined in the support collar and through a pair of the vertically spaced holes defined in the pivot beam to secure the vertical position of the support collar relative to the pivot beam.

4: The gate hinge of claim 2 wherein:
each axle brace is an angle bracket having a gate post flange defining a through hole to carry a fastener for engagement with the gatepost, and a perpendicular axle flange defining a medial through hole to carry a pivot axle.

5: The gate hinge of claim 2 wherein:
the gate pivot pin is releasably carried in and extends through the gate pivot pin hole defined in the pivoting gate bracket and though a pair of the lateral adjustment holes defined in the mounting brackets to positionally maintain the lateral position of the pivoting gate bracket and the gate relative to the pivot beam and the support collar.

6: The gate hinge of claim 2 further comprising:
a collar clamp communicating between a flange structurally carried at an upper end portion of the pivoting gate bracket and the inner end of the gate proximate the top rail, and a collar clamp communicating between a flange structurally carried at a bottom end portion of the pivoting gate bracket and the inner end of the gate proximate the bottom rail, each collar clamp having two opposing halves, each half having a fastener flange defining a through hole for a fastener at each opposing end portion and a medial curved portion to extend circumferentially partially about an inner end portion of the gate, and fasteners extending through the holes in the flanges to secure the collar halves to each other and to the gate and to the pivot beam flange.

7: A gate hinge for pivotally attaching a rigid gate having an inner end an outer end a top rail and a bottom rail to a gatepost allowing the gate to pivot simultaneously horizontally and vertically for motion over variable terrain, the gate hinge comprising in combination:
a single gate hinge having;
a pivot beam with a pivot axle at an upper end and a pivot axle at a lower end and defining plural vertically spaced height adjustment holes between the upper end and the lower end pivotally mounted to the gatepost with axle braces, each axle brace
having a gatepost flange defining a through hole for a fastener engaging with the gatepost, and an axle flange perpendicular to the gatepost flange defining a medial through hole to carry a pivot axle;
a support collar slidably carried on the pivot beam, the support collar
defining a through channel in which the pivot beam is slidably carried,
defining a height adjustment hole for a height securing pin releasably carried in and extending through the height adjustment hole and through a pair of the vertically spaced holes defined in the pivot beam to secure the vertical position of the support collar relative to the pivot beam, and
structurally carrying two parallel spacedly adjacent mounting brackets, each mounting bracket defining plural horizontally spaced lateral adjustment holes to carry a gate pivot pin; and
a pivoting gate bracket defining a medial gate pivot pin hole journaled between the mounting brackets on the gate pivot pin, the pivoting gate bracket
rigidly attached to the inner end portion of the gate with collar clamps communicating between a flange structurally carried at an upper end portion of the pivoting gate bracket and the gate proximate the top rail, and communicating between a flange structurally carried at a bottom end portion of the pivoting gate bracket and the gate proximate the bottom rail, each collar clamp having
two opposing halves, each half having a fastener flange at opposing end portions defining a hole for a fastener,
a medial curved portion to extend circumferentially partially about an inner end portion of the gate, and
fasteners extending through the holes in the fastener flanges to releasably secure the collar halves to each other, to the gate and to the pivot beam flange, and
the gate pivot pin is releasably carried in and extends through the gate pivot pin hole defined in the pivoting gate bracket and though a pair of the lateral adjustment holes defined in the mounting brackets to adjustably secure the lateral position of the pivoting gate bracket and the gate relative to the pivot beam the support collar and the gatepost.
